(19) United States
(12) Patent Application Publication
(10) Pub. No.: US 2011/0208647 A1
(43) Pub. Date: Aug. 25, 2011

(54) System and Method for Crowd-Based Resource and Data Management

(75) Inventors: Ed Messman, (US); Jeff Nunn, Dennison, TX (US)

(73) Assignee: GIVEO, INC., Boulder, CO (US)

(21) Appl. No.: 13/030,544

(22) Filed: Feb. 18, 2011

Related U.S. Application Data
(60) Provisional application No. 61/306,007, filed on Feb. 19, 2010.

(51) Int. Cl. G06Q 40/00; G06Q 50/00

(52) U.S. Cl. 705/39

(57) ABSTRACT

A system for crowd-based data and resource management, comprises, an application server adapted to perform a method of data management comprising providing an interface for posting an idea, providing an interface to search for an organization, providing an interface to enable a user to donate to the organization, providing an interface to share information about the organization, and providing an interface to view analytics about the organization.

### PRIORITY AND RELATED APPLICATIONS

The present application claims priority to U.S. Patent Application No. 61/306,007 filed on Feb. 19, 2010. The details of Application No. 61/306,007 are incorporated into the present application by reference and for all proper purposes.

### FIELD OF THE INVENTION

Aspects of the present application relate to crowd-based resource and data management, and more particularly, to a system and method for enabling corporations, foundations and other organizations to get more out of their charitable giving or donations by enabling a group of consumers and/or customers to login and vote for their favorite charity or idea.

### BACKGROUND OF THE INVENTION

Prior systems for charitable giving and data resource management fail to address the need to allow large groups of users to interactively participate and contribute to a charitable cause or other marketing campaign. Aspects of systems constructed in accordance with the present invention solve these problems.

### SUMMARY OF THE INVENTION

Aspects of the present invention comprises a system for crowd-based data and resource management, comprises, an application server adapted to perform a method of data management comprising providing an interface for posting an idea, providing an interface to search for an organization, providing an interface to enable a user to donate to the organization, providing an interface to share information about the organization, and providing an interface to view analytics about the organization.

### BRIEF DESCRIPTION OF THE DRAWING FIGURES

FIGS. 1-13 are examples of a user interface dashboard as implemented in accordance with various aspects of the present invention; and

FIG. 14 is a representative machine or other structure that may be used in connection with aspects of the present invention.

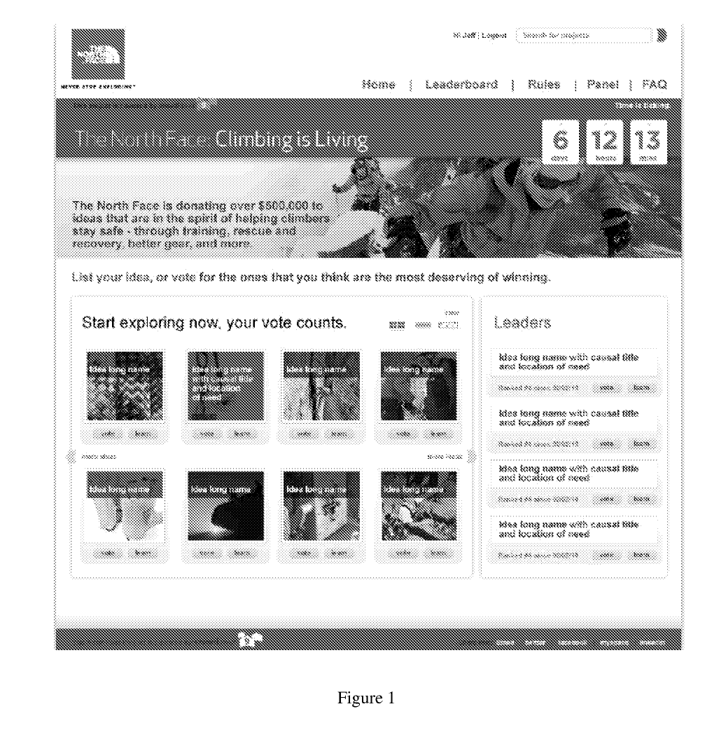

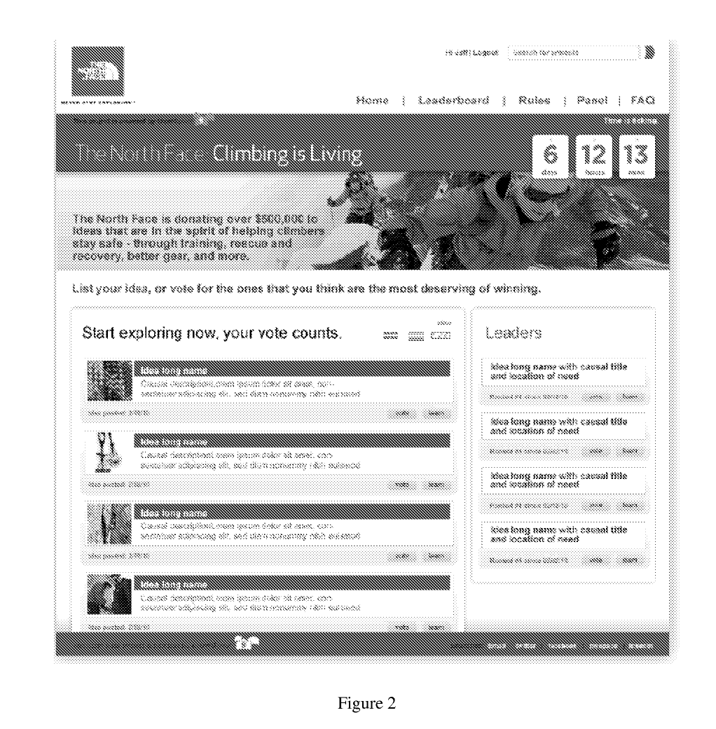

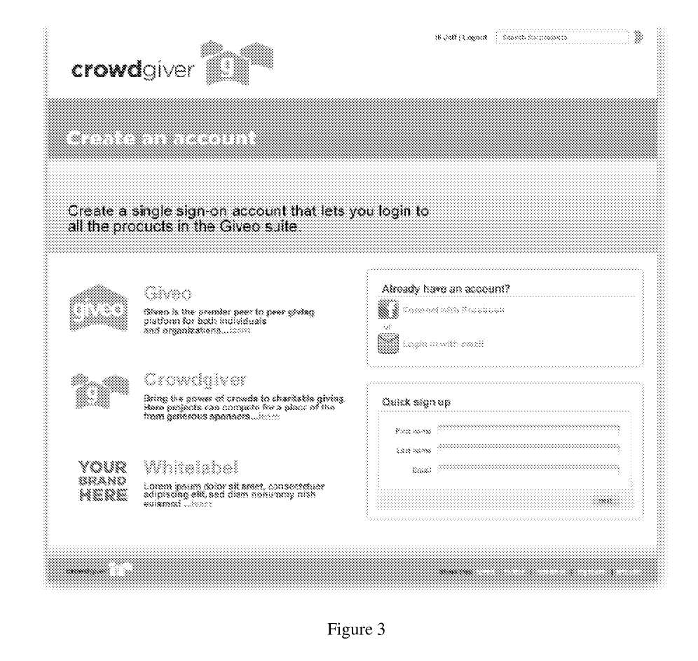

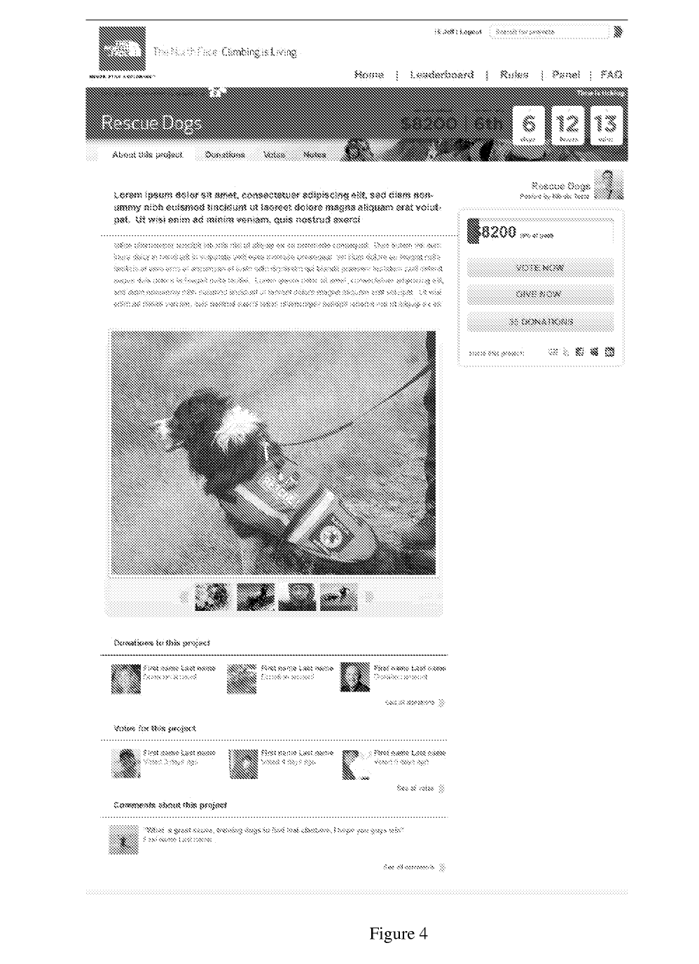

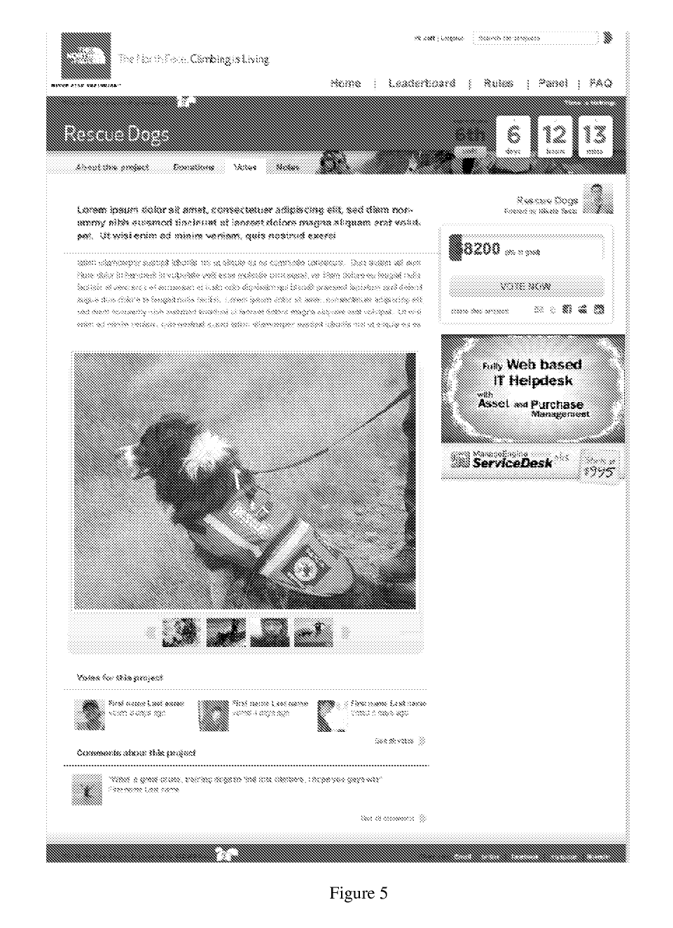

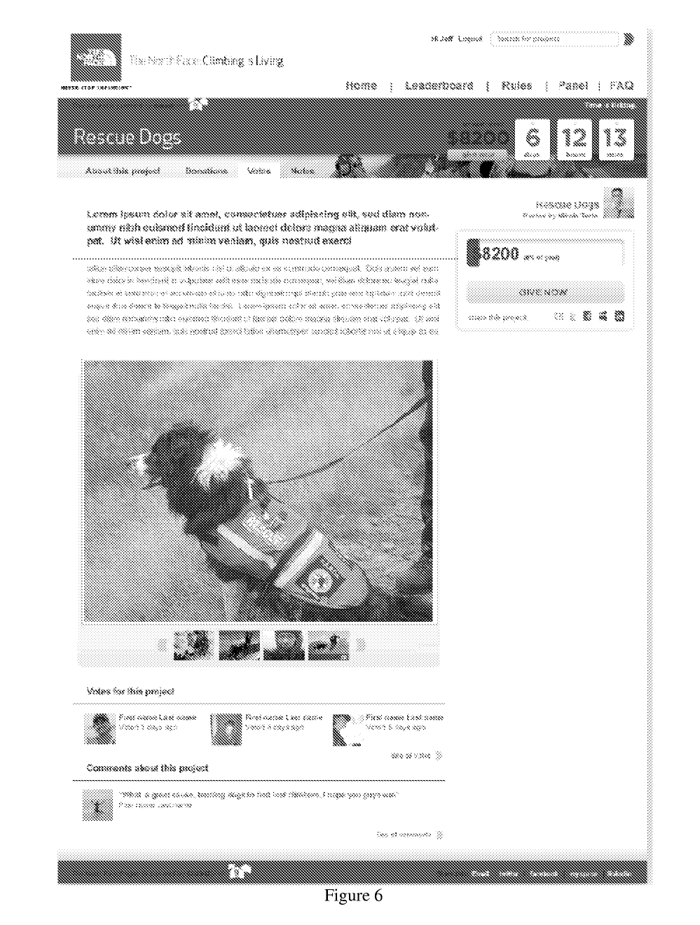

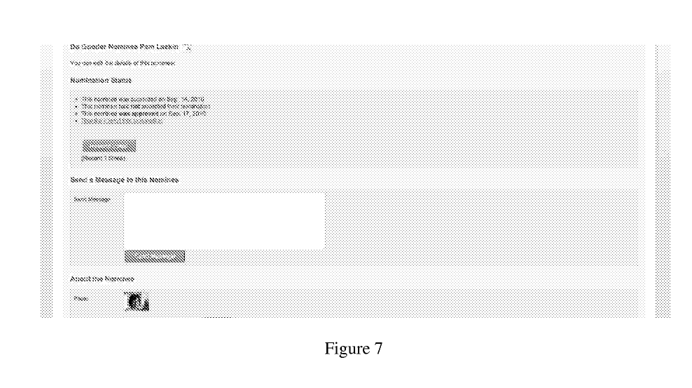

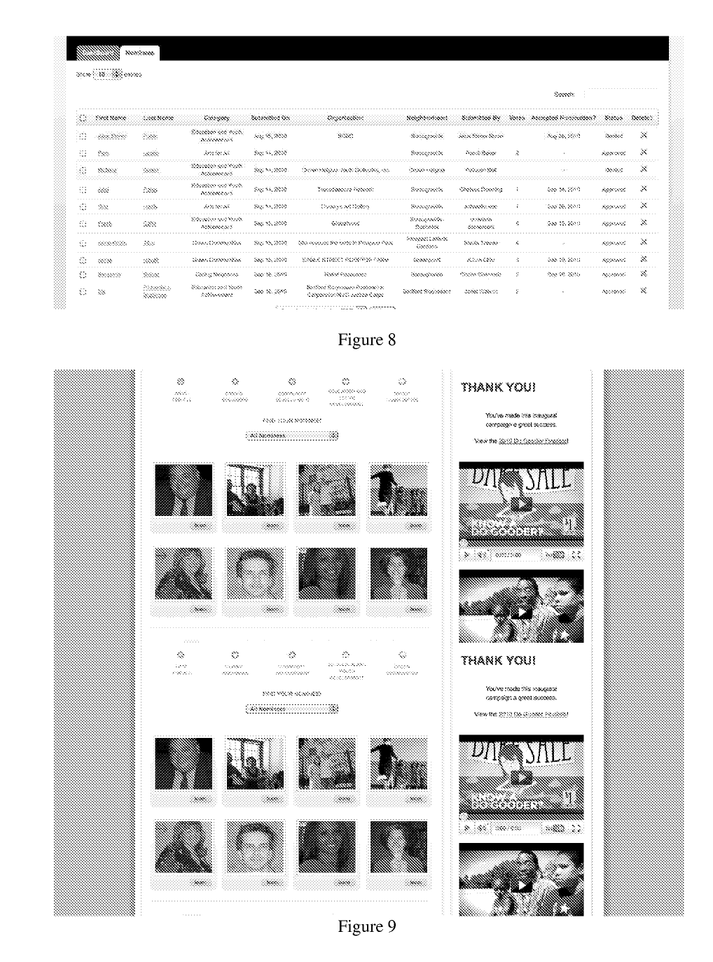

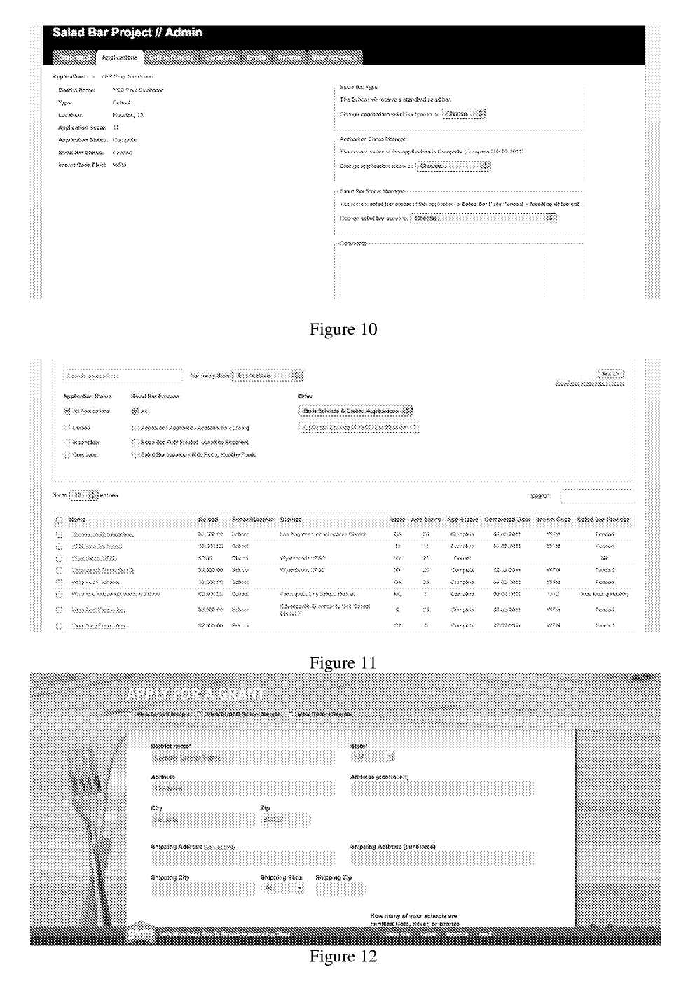

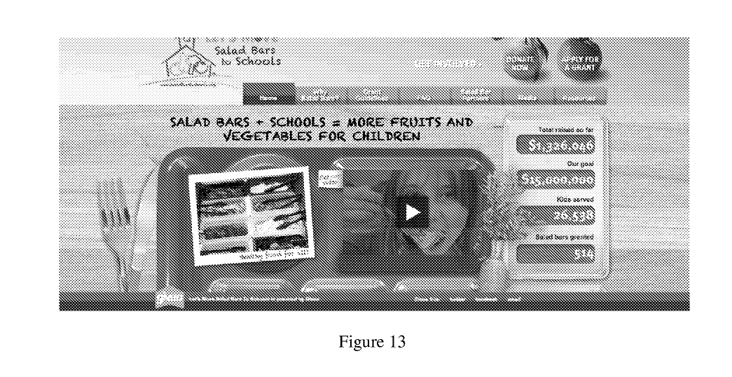

### DETAILED DESCRIPTION

CrowdGiver is a cause marketing platform that applies the elements of crowdsourcing to charitable giving. It allows corporations and foundations to get more out of their charitable giving or donations by enabling a group of consumers and/or customers to login and vote for their favorite charity or idea. The charity or idea with the most votes would qualify for a certain portion or all of the corporations or foundations charitable donation. The platform can be branded to look like the corporation or foundation so that it extends brand recognition.

For example, Starbucks gives away $1,000,000 to charities in any given year. Starbucks would use CrowdGiver to run one or multiple cause marketing campaigns that may engage one or multiple groups of customers. They could run one or multiple CrowdGiver campaigns where they allow certain customers to vote on which charities who support a certain categories of social need (fair trade, organic, kids education, poverty, planet, etc.) should receive a portion or all of their annual charitable giving. By running these campaigns they engage a group of consumers to vote for their favorite charity while extending their brand into a positive cause and exposing this group to a unique marketing message.

The CrowdGiver platform can be configured with a variety of elements, depending on the objectives of your marketing campaign. It could be configured into different applications with any combination of the following elements:
Post an Idea
Search for a charity
Donate to your favorite charity
Donate to your favorite idea
Share with friends by sending to friends via Facebook, Twitter, LinkedIn, Email
Comment regarding a specific charity
Comment regarding a specific idea
Run multiple campaigns simultaneously
Analytics per campaign
View a leaderboard

The screen shot images included herein represent several examples of the platform described above as it may be implemented on a machine, computer or other networked environment.

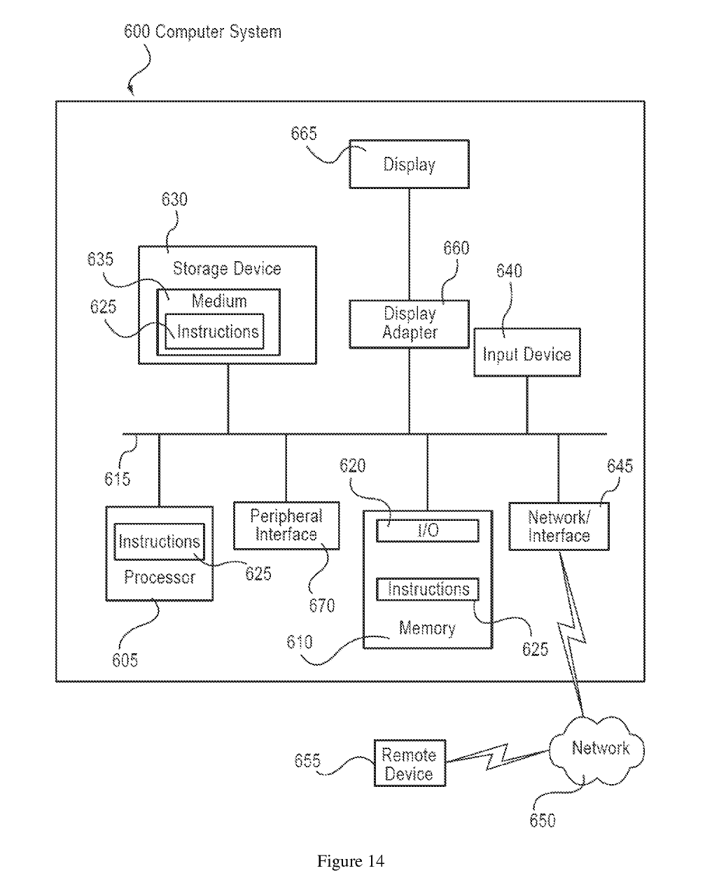

Structure and Machine Embodiment. With reference to FIG. 14, shown is a diagrammatic representation of one embodiment of a machine in the exemplary form of a computer system 600 within which a set of instructions for causing a device to perform any one or more of the aspects and/or methodologies of the present disclosure to be executed. Computer system 600 includes a processor 605 and a memory 610 that communicate with each other, and with other components, via a bus 615. Bus 615 may include any of several types of bus structures including, but not limited to, a memory bus, a memory controller, a peripheral bus, a local bus, and any combinations thereof, using any of a variety of bus architectures.

Memory 610 may include various components (e.g., machine readable media) including, but not limited to, a random access memory component (e.g., a static RAM “SRAM”, a dynamic RAM “DRAM, etc.), a read only component, and any combinations thereof. In one example, a basic input/output system 620 (BIOS), including basic routines that help to transfer information between elements within computer system 600, such as during start-up, may be stored in memory 610. Memory 610 may also include (e.g., stored on one or more machine-readable media) instructions (e.g., software) 625 embodying any one or more of the aspects and/or methodologies of the present disclosure. In another example, memory 610 may further include any number of program modules including, but not limited to, an operating system, one or more application programs, other program modules, program data, and any combinations thereof.

Computer system 600 may also include a storage device 630. Examples of a storage device (e.g., storage device 630) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 630 may be connected to bus 615 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 630 may be removably interfaced with computer system 600 (e.g., via an external port connector (not shown)). Particularly, storage device 630 and an associated machine-readable medium 635 may provide nonvolatile and/or volatile storage of machine-readable instructions, data structures, program modules, and/or other data for computer system 600. In one example, software 625 may reside, completely or partially, within machine-readable medium 635. In another example, software 625 may reside, completely or partially, within processor 605. Computer system 600 may also include an input device 640. In one example, a user of computer system 600 may enter commands and/or other information into computer system 600 via input device 640. Examples of an input device 640 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touch-screen, and any combinations thereof. Input device 640 may be interfaced to bus 615 via any of a variety of interfaces (not shown) including, but not limited to, a serial interface, a parallel interface, a game port, a USB interface, a FIREWIRE interface, a direct interface to bus 615, and any combinations thereof.

A user may also input commands and/or other information to computer system 600 via storage device 630 (e.g., a removable disk drive, a flash drive, etc.) and/or a network interface device 645. A network interface device, such as network interface device 645 may be utilized for connecting computer system 600 to one or more of a variety of networks, such as network 650, and one or more remote devices 655 connected thereto. Examples of a network interface device include, but are not limited to, a network interface card, a modem, and any combination thereof. Examples of a network or network segment include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 650, may employ a wired and/or a wireless mode of communication. In general, any network topology may be used. Information (e.g., data, software 625, etc.) may be communicated to and/or from computer system 600 via network interface device 645.

Computer system 600 may further include a video display adapter 660 for communicating a displayable image to a display device, such as display device 665. A display device may be utilized to display any number and/or variety of indicators related to pollution impact and/or pollution offset attributable to a consumer, as discussed above. Examples of a display device include, but are not limited to, a liquid crystal display (LCD), a cathode ray tube (CRT), a plasma display, and any combinations thereof. In addition to a display device, a computer system 600 may include one or more other peripheral output devices including, but not limited to, an audio speaker, a printer, and any combinations thereof. Such peripheral output devices may be connected to bus 615 via a peripheral interface 670. Examples of a peripheral interface include, but are not limited to, a serial port, a USB connection, a FIREWIRE connection, a parallel connection, and any combinations thereof. In one example an audio device may provide audio related to data of computer system 600 (e.g., data representing an indicator related to pollution impact and/or pollution offset attributable to a consumer).

A digitizer (not shown) and an accompanying stylus, if needed, may be included in order to digitally capture freehand input. A pen digitizer may be separately configured or coextensive with a display area of display device 665. Accordingly, a digitizer may be integrated with display device 665, or may exist as a separate device overlaying or otherwise appended to display device 665.

What is claimed is:

1. A system for crowd-based data and resource management, comprising:
an application server adapted to perform a method of data management comprising:
providing an interface for posting an idea;
providing an interface to search for an organization;
providing an interface to enable a user to donate to the organization;
providing an interface to share information about the organization; and
providing an interface to view analytics about the organization.
